(19) United States
(12) Patent Application Publication
(10) Pub. No.: US 2013/0111705 A1
(43) Pub. Date: May 9, 2013

(54) LOCATION STABILIZING STRUCTURE FOR ENCLOSURE-TYPE ROTARY SHAFT

(71) Applicants: CHIEN CHENG MAI, NEW TAIPEI CITY (TW); AN SZU HSU, NEW TAIPEI CITY (TW); CHIEN NAN TSAI, NEW TAIPEI CITY (TW)

(72) Inventors: CHIEN CHENG MAI, NEW TAIPEI CITY (TW); AN SZU HSU, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/292,144

(22) Filed: Nov. 9, 2011

(51) Int. Cl. E05D 11/08

(52) U.S. Cl. 16/342

(57) ABSTRACT

A location stabilizing structure for enclosure-type rotary shaft includes a fitting member having an enclosure section and a shaft member having a shaft rod tightly enclosed in the enclosure section. The enclosure section has multiple inner adaptive faces. The shaft rod has multiple outer adaptive faces in adaptation to the inner adaptive faces for matching the inner adaptive faces. The number of matching inner adaptive faces and outer adaptive faces is varied with the change of angular position between the enclosure section and the shaft rod. The locating/stabilizing structure is designed with different numbers of matching inner and outer adaptive faces indifferent angular positions to provide different locating force. Indifferent angular positions, the unmatching inner adaptive faces and outer adaptive faces interfere with each other to provide radial elastic compressing force to securely locate the rotary shaft and avoid loosening or swinging.

### BACKGROUND OF THE INVENTION

1. Field of the Invention

The present invention relates generally to a location stabilizing structure for enclosure-type rotary shaft, and more particularly to a rotary shaft structure, which can enhance stability of location between the fitting member and the shaft member and improve operation hand feeling.

2. Description of the Related Art

Various snap-on covers have been widely applied to the current fashionable electronic products such as portable computers, electronic secretaries, portable audio/video players and mobile phones. At least one pivotal structure is selectively mounted between the edges of the main body and the cover body, whereby the cover body can be repeatedly pivotally rotated open or closed to cover the main body. The quality of the pivotal structure directly affects the convenience and operation hand feeling of the product. More importantly, the rotary shaft of the pivotal structure needs to enable a user to freely and stably locate the cover body in any angular position. Also, the pivotal structure must be durable without loosening after a long period of use. Furthermore, the pivotal structure must provide a good easy-open and hard-close hand feeling.

In the existent rotary structures, there is an axial series friction-type rotary shaft structure. Such rotary shaft structure has a shaft member on which multiple axial frictional members are serially connected. The frictional members provide compression effect to increase the frictional resistance against rotation between the shaft member and a rotary member fitted around the shaft member. Accordingly, the rotary member can be freely located in any angular position. However, such structure cannot provide enhanced braking (locking) effect for the rotary member in a specific angular position. Moreover, after a period of repeated use, the frictional members are gradually subject to wear. This will lead to deterioration of the fastening/compression effect to cause loosening of the rotary member. As a result, the rotary member can be hardly securely located and will become loosened to make noise in rotation operation. Many manufacturers have tried to overcome this problem but failed. Such axial series friction-type rotary shaft structure is not included in the scope of the present invention and thus will not be further discussed hereinafter.

The present invention relates to an enclosure-type rotary shaft structure relevant to the conventional fitting-type rotary shaft, that is, the so-called radial frictional rotary shaft structure. Such type of rotary shaft is generally composed of a fitting member and a shaft member axially fitted with the fitting member. One end of the fitting member is formed with a sleeve or enclosure section.

The shaft member has a shaft rod enclosed in the sleeve or the enclosure section. At the early stage, the shaft rod is formed with an axial split to provide radial elastic contraction/expansion function for the shaft rod. In this case, the shaft rod can be forcedly elastically inserted into the sleeve or the enclosure section. Accordingly, when the shaft rod is rotated within the sleeve or the enclosure section, a frictional torsion is applied to the shaft rod for freely locating the shaft member in any desired angular position. However, such structure still cannot provide a set enhanced braking effect for the shaft member in a specific angular position.

To overcome the above problem, an improved rotary shaft structure has been developed, which can automatically enhance the braking effect for the shaft member in a specific angular position. The surface of the shaft rod of the shaft member is formed with an adaptive plane face. The fitting member has an arcuate enclosure section corresponding to the outer diameter of the shaft rod and a tapered contracted section non-conforming to the outer diameter of the shaft rod. A gap is reserved between the rolled end edges of the enclosure section and the contracted section. The shaft rod is enclosed and connected in a shaft insertion space defined by the enclosure section and the contracted section. The shaft rod is fastened in the shaft insertion space to provide a freely locating effect. The rolled end edge of the contracted section serves to abut against the adaptive plane face of the shaft rod in a certain specific angular position to provide enhanced braking or automatic locking effect.

Another improved rotary shaft structure includes a fitting member and a shaft member. One end of the fitting member is formed with a hollow sleeve or enclosure section cut with an axial split. The inner wall of the sleeve or the enclosure section is further formed with an inner adaptive plane face. The shaft rod of the shaft member is formed with an outer adaptive plane face corresponding to the inner adaptive plane face. When the shaft member is rotated to a certain angular position relative to the fitting member, the inner and outer adaptive plane faces match each other to provide an enhanced braking effect. Moreover, in an unmatching state, the inner and outer adaptive plane faces interfere with and push each other. Therefore, when traveling to an angular position close to the matching point, the shaft member is automatically pushed and rotated to a matching position. When applied to a device, a short-distance automatic closing/opening effect is provided for the device to facilitate use.

The above rotary shaft structures have freely locating effect and is able to enhance the braking effect in a specific angular position and achieve a short-distance automatic push closing/opening effect. However, in practice, there are still some shortcomings existing in these rotary shaft structures as follows:

1. After a period of repeated opening/closing operation, the sleeve or enclosure section of the fitting member is still likely to elastically fail and loosen due to the push of the shaft rod of the shaft member. In the matching state of the inner and outer adaptive plane faces, the shaft member often loosens and swings.

2. Due to the enhanced braking effect and the automatic push closing/opening effect, a greater operation force is needed. Therefore, the rotary shaft structure cannot provide a good easy-open and hard-close operation hand feeling.

3. The fastening force between the fitting member and the shaft member will be deteriorated due to the wear of the shaft rod and the sleeve or enclosure section. As a result, the shaft member will become loosened after a period of use.

### SUMMARY OF THE INVENTION

It is therefore a primary object of the present invention to provide a location stabilizing structure for enclosure-type rotary shaft. The location stabilizing structure includes a fitting member and a shaft member fitted and assembled with the fitting member. The fitting member has an enclosure section and the shaft member has a shaft rod tightly enclosed in the enclosure section. The enclosure section has multiple inner adaptive faces, while the shaft rod has multiple outer adaptive faces in adaptation to the inner adaptive faces for matching the inner adaptive faces. The number of matching inner adaptive faces and outer adaptive faces is varied with the change of angular position between the enclosure section and the shaft rod. Accordingly, the rotary shaft has different locating force in different angular positions. Therefore, it is easy to set and provide different locating force to respectively meet the requirements of the relative rotary members in specific opened/closed angular positions.

It is a further object of the present invention to provide the above location stabilizing structure for enclosure-type rotary shaft, in which a rotation start point and a rotation end point are provided between the enclosure section and the shaft rod. The number of the matching inner adaptive faces and outer adaptive faces at the start point is equal or unequal to the number of the matching inner adaptive faces and outer adaptive faces at the end point. Accordingly, the rotary shaft can provide a desired operation hand feeling (such as easy-open and hard-close hand feeling).

It is still a further object of the present invention to provide the above location stabilizing structure for enclosure-type rotary shaft, in which some of the inner adaptive faces and outer adaptive faces match each other to enhance the locating force, while some other inner adaptive faces and outer adaptive faces (including a preset interference section at a free end of the enclosure section) unmatch each other to cause interference and push between the fitting member and the shaft member. Accordingly, the enclosure section and the shaft rod are elastically fastened to provide automatic pushing/pulling closing/opening effect to facilitate use. Moreover, the rotary shaft is prevented from loosening or swinging even after a long period of use.

The present invention can be best understood through the following description and accompanying drawings, wherein:

### BRIEF DESCRIPTION OF THE DRAWINGS

FIG. 1 is a perspective exploded view of a first embodiment of the present invention, in which the enclosure section has two inner adaptive faces and the shaft rod has three outer adaptive faces;

FIG. 2 is a perspective assembled view of the first embodiment of the present invention according to FIG. 1;

FIG. 3 is a side view of the first embodiment of the present invention in a closed state according to FIG. 2;

FIG. 3A is an enlarged view of a part of FIG. 3;

FIG. 4 is a side view of the first embodiment of the present invention in a fully open state according to FIG. 2;

FIG. 4A is an enlarged view of a part of FIG. 4;

FIG. 5 is a perspective exploded view of a second embodiment of the present invention, in which the enclosure section has three inner adaptive faces and the shaft rod has fourth outer adaptive faces;

FIG. 6 is a perspective assembled view of the second embodiment of the present invention according to FIG. 5;

FIG. 7 is a side view of a part of the second embodiment of the present invention in a closed state according to FIG. 6;

FIG. 8 is a side view of a part of the second embodiment of the present invention in a partially open state according to FIG. 6; and

FIG. 9 is a side view of a part of the second embodiment of the present invention in a fully open state according to FIG. 9.

### DETAILED DESCRIPTION OF THE PREFERRED EMBODIMENTS

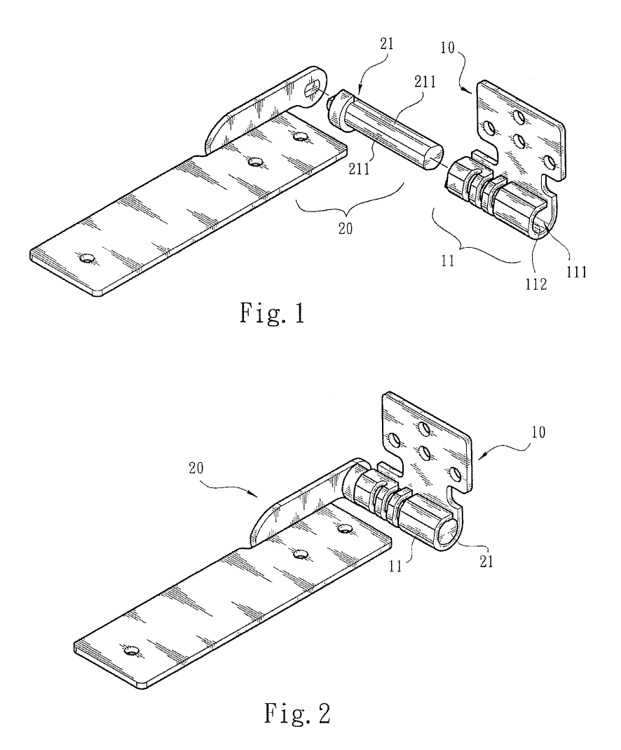

Please refer to FIGS. 1 to 3. The location stabilizing structure for enclosure-type rotary shaft of the present invention at least includes a fitting member 10 and a shaft member 20 fitted and assembled with the fitting member 10. The fitting member 20 at least has an enclosure section 11 (or sleeve section) with an internal shaft enclosing space 111. The inner wall of the shaft enclosing space 111 is substantially in the form of a roll with an inner diameter of an arc. In addition, the inner wall of the shaft enclosing space 111 is respectively formed with multiple inner adaptive faces 112 (plane faces or non-planar faces) in different angular sectors, which non-conform to the inner diameter of the arc. Moreover, a free end of the enclosure section 11 can be formed with an interference section 113 different from the inner diameter of the arc.

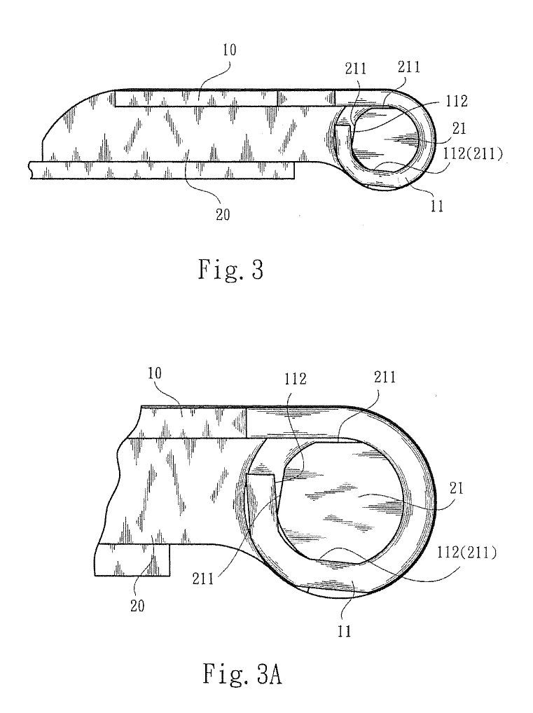

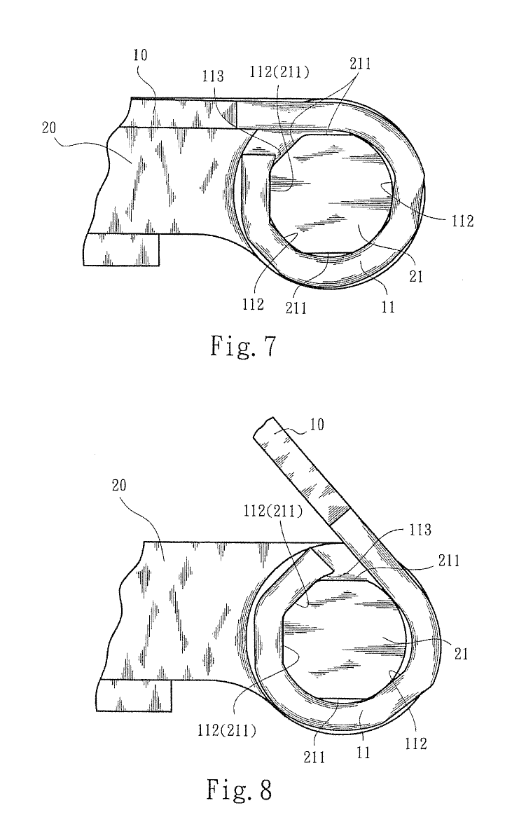

The shaft member 20 at least has a shaft rod 21, which can be inserted into the enclosure section 11. Preferably, the diameter of the shaft rod 21 is not smaller than the inner diameter of the arc. The circumference of the shaft rod 21 is formed with multiple outer adaptive faces 211 in adaptation to the inner adaptive faces 112 of the fitting member 10. The number of the outer adaptive faces 211 is equal to or unequal to the number of the inner adaptive faces 112. In addition, the outer adaptive faces 211 in the angular sectors of the shaft rod 21 can be respectively different from the inner adaptive faces 112 in the angular sectors of the shaft enclosing space 111 of the enclosure section 11. Accordingly, when the shaft rod 21 is inserted in the shaft enclosing space 111 of the enclosure section 11, the number of the matching inner adaptive faces 112 and outer adaptive faces 211 is varied with the change of rotational amount between the fitting member 10 and the shaft member 20 so as to adjust the locating force. For example, when the fitting member 10 and the shaft member 20 are in a closed state (with reference to FIGS. 3 and 7), the inner adaptive faces 112 are set to match only one single outer adaptive face 211, while the other inner and outer adaptive faces 112, 211 angularly interfere with each other to a certain extent and unmatch each other. Therefore, the locating force in a certain position is mainly provided by the conforming inner and outer adaptive faces. The other inner and outer adaptive faces 112, 211 that angularly interfere with each other to a certain extent and unmatch each other result in the interference and push between the enclosure section and the shaft rod. Accordingly, the enclosure section and the shaft rod are elastically fastened and prevented from loosening or swinging.

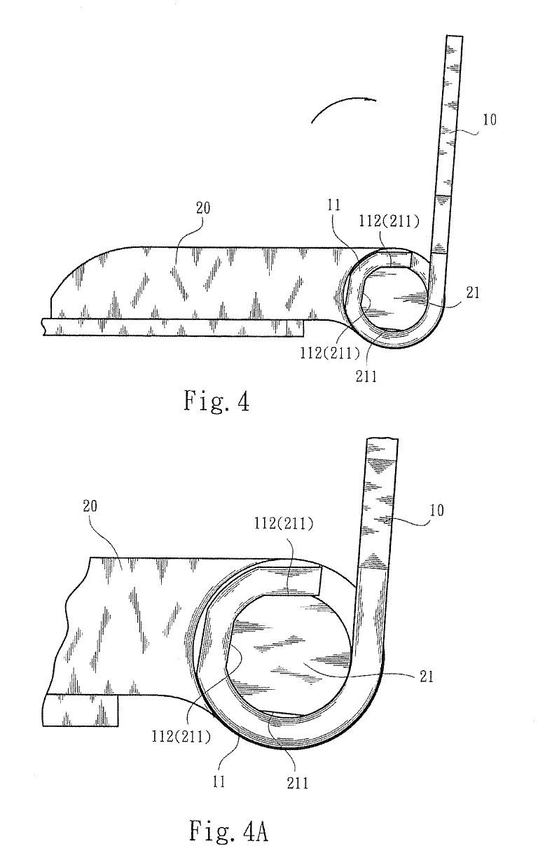

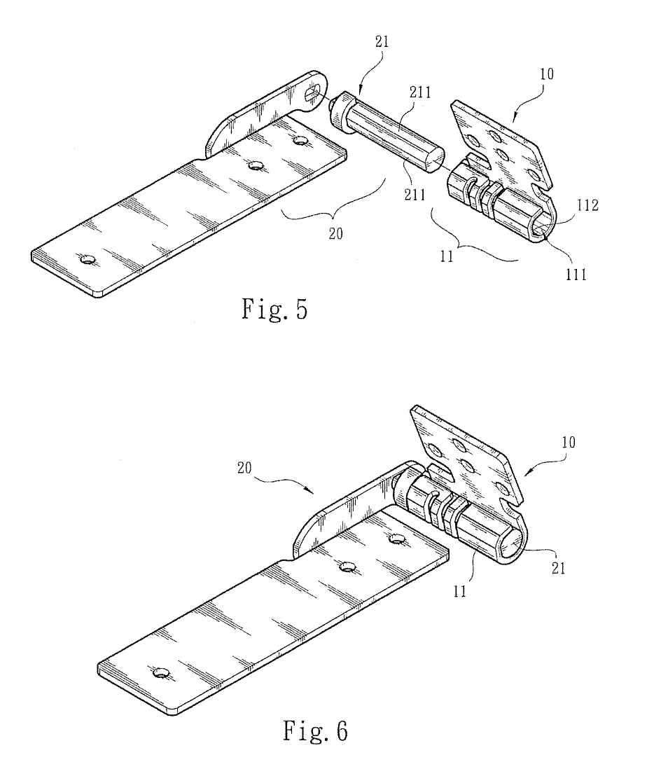

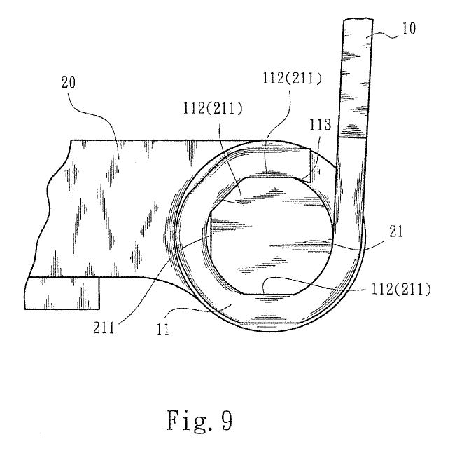

When the fitting member 10 and the shaft member 20 are in an open state (with reference to FIGS. 4 and 9), the inner adaptive faces 112 (including the interference section 113) are set to match at least two outer adaptive faces 211. In this case, in the open position, the locating force is increased. Also, the other inner and outer adaptive faces unmatch each other to elastically fasten the enclosure section and the shaft rod and prevent the enclosure section and the shaft rod from loosening or swinging. In comparison between the aforesaid two states, it is found that in the closed state, the number of the matching inner and outer adaptive faces is smaller than that in the open state so that the locating force between the fitting member 10 and the shaft member 20 in the closed state is less than the locating force between the fitting member 10 and the shaft member 20 in the open state. Accordingly, the above structure can provide an easy-open and hard-close effect. Therefore, as necessary, the present invention can be designed with different numbers of matching inner and outer adaptive faces in different angular positions (with reference to FIGS. 3, 4, 7, 8 and 9) to provide different locating force. Moreover, the numbers of matching inner and outer adaptive faces are varied with the change of the angular positions, whereby the enclosure section 11 and the shaft rod 21 normally interfere with and fasten/compress each other to avoid loosening or swinging between the enclosure section 11 and the shaft rod 21 in the located state. Therefore, the shortcoming existing in the prior art is eliminated.

Moreover, when the enclosure section 11 and the shaft rod 21 interfere with and fasten/compress each other, a short-distance automatic pushing/pulling effect is obviously provided in positions close to the matching points of the inner and outer adaptive faces. Especially, in the positions close to the rotation start point and end point of the fitting member 10 and the shaft member 20, an automatic pushing/pulling closing effect and an automatic pushing/pulling fully opening effect are provided to facilitate use.

In conclusion, the structural design of the present invention provides different locating force in different angular positions to avoid loosening and overcome the shortcomings existing in the conventional rotary shafts. The present invention also provides diversified and higher-quality applications.

The above embodiments are only used to illustrate the present invention, not intended to limit the scope thereof. Many modifications of the above embodiments can be made without departing from the spirit of the present invention.

What is claimed is:

1. A location stabilizing structure for enclosure-type rotary shaft, at least comprising a fitting member and a shaft member fitted and assembled with the fitting member, wherein the fitting member has an enclosure section and the shaft member has a shaft rod, the shaft rod being tightly enclosed in the enclosure section, the enclosure section having inner adaptive faces, the shaft rod having outer adaptive faces in adaptation to the inner adaptive faces for matching the inner adaptive faces, the number of matching inner adaptive faces and outer adaptive faces being varied with the change of angular position between the enclosure section and the shaft rod.

2. The location stabilizing structure for enclosure-type rotary shaft as claimed in claim 1, wherein the number of the inner adaptive faces is unequal to the number of the outer adaptive faces.

3. The location stabilizing structure for enclosure-type rotary shaft as claimed in claim 1, wherein the number of the inner adaptive faces is equal to the number of the outer adaptive faces.

4. The location stabilizing structure for enclosure-type rotary shaft as claimed in claim 1, wherein the inner and outer adaptive faces are plane faces.

5. The location stabilizing structure for enclosure-type rotary shaft as claimed in claim 2, wherein the inner and outer adaptive faces are plane faces.

6. The location stabilizing structure for enclosure-type rotary shaft as claimed in claim 3, wherein the inner and outer adaptive faces are plane faces.

7. The location stabilizing structure for enclosure-type rotary shaft as claimed in claim 1, wherein the inner and outer adaptive faces are non-planar faces.

8. The location stabilizing structure for enclosure-type rotary shaft as claimed in claim 2, wherein the inner and outer adaptive faces are non-planar faces.

9. The location stabilizing structure for enclosure-type rotary shaft as claimed in claim 3, wherein the inner and outer adaptive faces are non-planar faces.

10. The location stabilizing structure for enclosure-type rotary shaft as claimed in claim 1, wherein a free end of the enclosure section is formed with an interference section.

11. The location stabilizing structure for enclosure-type rotary shaft as claimed in claim 2, wherein a free end of the enclosure section is formed with an interference section.

12. The location stabilizing structure for enclosure-type rotary shaft as claimed in claim 3, wherein a free end of the enclosure section is formed with an interference section.

13. The location stabilizing structure for enclosure-type rotary shaft as claimed in claim 4, wherein a free end of the enclosure section is formed with an interference section.

14. The location stabilizing structure for enclosure-type rotary shaft as claimed in claim 7, wherein a free end of the enclosure section is formed with an interference section.

15. The location stabilizing structure for enclosure-type rotary shaft as claimed in claim 1, wherein a relative rotation start point and a relative rotation end point are provided between the enclosure section and the shaft rod, the number of the matching inner adaptive faces and outer adaptive faces at the start point being smaller than the number of the matching inner adaptive faces and outer adaptive faces at the end point.

16. The location stabilizing structure for enclosure-type rotary shaft as claimed in claim 2, wherein a relative rotation start point and a relative rotation end point are provided between the enclosure section and the shaft rod, the number of the matching inner adaptive faces and outer adaptive faces at the start point being smaller than the number of the matching inner adaptive faces and outer adaptive faces at the end point.

17. The location stabilizing structure for enclosure-type rotary shaft as claimed in claim 3, wherein a relative rotation start point and a relative rotation end point are provided between the enclosure section and the shaft rod, the number of the matching inner adaptive faces and outer adaptive faces at the start point being smaller than the number of the matching inner adaptive faces and outer adaptive faces at the end point.

18. The location stabilizing structure for enclosure-type rotary shaft as claimed in claim 10, wherein a relative rotation start point and a relative rotation end point are provided between the enclosure section and the shaft rod, the number of the matching inner adaptive faces and outer adaptive faces at the start point being smaller than the number of the matching inner adaptive faces and outer adaptive faces at the end point.

19. The location stabilizing structure for enclosure-type rotary shaft as claimed in claim 1, wherein a relative rotation start point and a relative rotation end point are provided between the enclosure section and the shaft rod, the number of the matching inner adaptive faces and outer adaptive faces at the start point being equal to the number of the matching inner adaptive faces and outer adaptive faces at the end point.

20. The location stabilizing structure for enclosure-type rotary shaft as claimed in claim 2, wherein a relative rotation start point and a relative rotation end point are provided between the enclosure section and the shaft rod, the number of the matching inner adaptive faces and outer adaptive faces at the start point being equal to the number of the matching inner adaptive faces and outer adaptive faces at the end point.

21. The location stabilizing structure for enclosure-type rotary shaft as claimed in claim 3, wherein a relative rotation start point and a relative rotation end point are provided between the enclosure section and the shaft rod, the number of the matching inner adaptive faces and outer adaptive faces at the start point being equal to the number of the matching inner adaptive faces and outer adaptive faces at the end point.

22. The location stabilizing structure for enclosure-type rotary shaft as claimed in claim 10, wherein a relative rotation start point and a relative rotation end point are provided between the enclosure section and the shaft rod, the number of the matching inner adaptive faces and outer adaptive faces at the start point being equal to the number of the matching inner adaptive faces and outer adaptive faces at the end point.

23. The location stabilizing structure for enclosure-type rotary shaft as claimed in claim 1, wherein the enclosure section is in the form of a sleeve section.

24. The location stabilizing structure for enclosure-type rotary shaft as claimed in claim 2, wherein the enclosure section is in the form of a sleeve section.

25. The location stabilizing structure for enclosure-type rotary shaft as claimed in claim 3, wherein the enclosure section is in the form of a sleeve section.

26. The location stabilizing structure for enclosure-type rotary shaft as claimed in claim 10, wherein the enclosure section is in the form of a sleeve section.

27. The location stabilizing structure for enclosure-type rotary shaft as claimed in claim 15, wherein the enclosure section is in the form of a sleeve section.

28. The location stabilizing structure for enclosure-type rotary shaft as claimed in claim 16, wherein the enclosure section is in the form of a sleeve section.

29. The location stabilizing structure for enclosure-type rotary shaft as claimed in claim 17, wherein the enclosure section is in the form of a sleeve section.

30. The location stabilizing structure for enclosure-type rotary shaft as claimed in claim 19, wherein the enclosure section is in the form of a sleeve section.

31. The location stabilizing structure for enclosure-type rotary shaft as claimed in claim 20, wherein the enclosure section is in the form of a sleeve section.

32. The location stabilizing structure for enclosure-type rotary shaft as claimed in claim 21, wherein the enclosure section is in the form of a sleeve section.
